(19) United States
(12) Patent Application Publication
(10) Pub. No.: US 2014/0369912 A1
(43) Pub. Date: Dec. 18, 2014

(54) Integrated Supports for Emission Control Catalysts

(71) Applicant: BASF Corporation, Florham Park, NJ (US)

(72) Inventors: Xiaolai Zheng, Princeton Junction, NJ (US); Knut Wassermann, Princeton, NJ (US); Michel Deeba, East Brunswick, NJ (US); Mirko Arnold, Bedminster, NJ (US); René Koenig, Ludwigshafen (DE)

(21) Appl. No.: 14/300,720

(22) Filed: Jun. 10, 2014

Related U.S. Application Data
(60) Provisional application No. 61/834,620, filed on Jun. 13, 2013.

(51) Int. Cl. B01J 23/63; B01D 53/94; B01J 23/10

(52) U.S. Cl. CPC B01J 23/63; B01J 23/10; B01D 53/945
USPC 423/213.5; 502/439; 502/304; 502/303; 422/168

(57) ABSTRACT

Provided is a composite of mixed metal oxides comprising by weight of the composite: alumina in an amount in the range of 1 to 50%; ceria in an amount in the range of 1 to 50% zirconia in an amount in the range of 10 to 70%; and one or more oxides of Group II elements in an amount in the range of 1 to 10%; optionally, one or more oxides Group III elements in an amount in the range of 0 to 20% is present. The mixed metal oxides may be effective integrated supports for precious metals used in emissions catalysts where a single component is an integration of alumina, ceria, zirconia, Group III metal oxides (dopants, e.g., La₂O₃, Y₂O₃, Nd₂O₃, Pr₆O₁₁), Group II metal oxides (additives, e.g., BaO, SrO, CaO, MgO), and optionally other transition metal oxides.

### CROSS-REFERENCE TO RELATED APPLICATIONS

This application claims priority under 35 U.S.C. §119(e) to U.S. patent application Ser. No. 61/834,620, filed Jun. 13, 2013, which is hereby incorporated by reference in its entirety.

### TECHNICAL FIELD

The present invention relates to materials used to prepare catalytic washcoats used on substrates for emissions treatment systems and methods of making these materials. Also provided are methods for reducing contaminants in exhaust gas streams. Embodiments of the invention are directed to integrated supports for emission control catalysts. Specifically provided are mixed metal oxide materials of ceria-zirconia-alumina along with one or more Group II metal oxides and optionally one or more Group III metal oxides and transition metal oxides. The mixed metal oxide materials represent the integrated supports that have all necessary catalytic components, except platinum group metals, for three-way conversion catalysis.

### BACKGROUND

Three-way conversion (TWC) catalysts are used in engine exhaust streams to catalyze the oxidation of the unburned hydrocarbons (HCs) and carbon monoxide (CO) and the reduction of nitrogen oxides (NOx) to nitrogen. The presence of an oxygen storage component (OSC) in a TWC catalyst allows oxygen to be stored during (fuel) lean conditions to promote reduction of NOx adsorbed on the catalyst, and to be released during (fuel) rich conditions to promote oxidation of HCs and CO adsorbed on the catalyst. TWC catalysts typically comprise one or more platinum group metals (PGM) (e.g., platinum, palladium, rhodium, and/or iridium) located upon a support such as a high surface area, refractory oxide support, e.g., a high surface area alumina or a composite support such as a ceria-zirconia composite. The ceria-zirconia composite can also provide oxygen storage capacity. The support is carried on a suitable carrier or substrate such as a monolithic carrier comprising a refractory ceramic or metal honeycomb structure, or refractory particles such as spheres or short, extruded segments of a suitable refractory material.

PGM-containing catalytic converters are typically made from multiple components. With respect to three-way conversion (TWC) catalysts, for instance, dopant-stabilized ceria-zirconia, zirconia, and alumina are the most commonly used supports for PGM. In a conventional formulation process, PGM are dispersed onto different supports which are then slurried in the presence of additives. The slurry, upon reducing particle size by milling, forms a washcoat by coating a monolithic carrier. In such a process, the slurry formulation step has many variables which are oftentimes not easy to control.

There is a continuing need in the art for catalytic materials that are made efficiently and whose ingredients are used efficiently.

### SUMMARY

Provided are composites of mixed metal oxides, along with methods of making and using the same. In a first aspect, a composite of mixed metal oxides comprises, by weight of the composite: alumina in an amount in the range of 1 to 50%; ceria in an amount in the range of 1 to 50% zirconia in an amount in the range of 10 to 70%; and one or more oxides of Group II elements in an amount in the range of 1 to 10%; optionally, one or more oxides Group III elements in an amount in the range of 0 to 20% is present. The mixed metal oxides may have a BET specific surface area of at least 24 m²/g after aging at 1050° C. for 12 hours in air plus 10% steam. The mixed metal oxides may be effective as an oxygen storage component and/or a precious metal support. The ceria and zirconia may be provided as a solid solution of ceria-zirconia. The alumina may be formed from a colloidal alumina precursor.

In one or more embodiments, the one or more oxides of Group II elements comprises baria, strontia, calcia, magnesia, or combinations thereof. In one or more embodiments, the one or more oxides of Group III elements comprises yttria, praseodymia, lanthana, neodymia, or combinations thereof.

In a detailed embodiment, the mixed metal oxides comprise, by weight: alumina in an amount in the range of 10 to 35%; ceria in an amount in the range of 5 to 35%; zirconia in an amount in the range of 35 to 55%; baria, strontia, calcia, magnesia, or combinations thereof in an amount in the range of 1 to 5%; and lanthana yttria, praseodymia, neodymia, or combinations thereof in an amount in the range of 2 to 15%.

Another aspect is an automotive catalyst composite comprising a catalytic material on a carrier, the catalytic material comprising: a first precious metal supported on a first integrated support. In one or more embodiments, the first integrated support comprises, by weight: alumina in an amount in the range of 1 to 50%; ceria in an amount in the range of 1 to 50% zirconia in an amount in the range of 10 to 70%; and one or more oxides of Group II elements in an amount in the range of 1 to 10%; optionally, one or more oxides Group III elements in an amount in the range of 0 to 20% is present.

The first integrated support may be effective as the only precious metal support of the catalytic material. In one or more embodiments, the catalytic material is free from bulk alumina and/or ceria and/or zirconia. The ceria and zirconia may be provided as a solid solution of ceria-zirconia. The alumina may be formed from a colloidal alumina precursor. In an embodiment, the first precious metal comprises platinum, palladium, rhodium, or combinations thereof.

A further embodiment provides that when the first precious metal comprises palladium, platinum, or both, and not rhodium, and the catalytic material further comprises a second precious metal comprising rhodium on a second integrated support that comprises alumina, ceria, zirconia, and optionally an oxide of a Group III element. For example, the second integrated support comprises in an embodiment: alumina in an amount in the range of 1 to 50%; ceria in an amount in the range of 1 to 50%; and zirconia in an amount in the range of 10 to 70%; optionally, one or more oxides of Group II elements in an amount in the range of 0 to 10% is present; optionally, one or more oxides Group III elements in an amount in the range of 0 to 20% is present.

A detailed embodiment provides that the first precious metal comprises palladium, platinum, or both, and the first integrated support comprises, by weight of the first integrated support: alumina in an amount in the range of 1 to 30%; ceria in an amount in the range of 25 to 50%; zirconia in an amount in the range of 10 to 70%; and baria and/or strontia in an amount in the range of 1 to 10%; optionally, yttria, praseodymia, lanthana, neodymia, or combinations thereof in an amount in the range of 0 to 20%.

Another detailed embodiment provides that the first precious metal comprises rhodium, platinum, or both, and the first integrated support comprises, by weight of the first integrated support: alumina in an amount in the range of 1 to 30%; ceria in an amount in the range of 5 to 20%; zirconia in an amount in the range of 10 to 70%; and baria and/or strontia in an amount in the range of 1 to 10%; optionally, yttria, praseodymia, lanthana, neodymia, or combinations thereof in an amount in the range of 0 to 20% is present.

In one embodiment, the automotive catalyst composites are formed from a single washcoat. In this way, a first precious metal is supported on a first integrated support and a second precious metal is supported on a second integrated support, wherein the second precious metal and the second integrated support are different from the first precious metal and the first integrated support.

In another embodiment, the automotive catalyst composites are formed from more than one washcoat, each having a unique integrated support and combination of precious metals. For example, a first washcoat comprises a first precious metal supported on a first integrated support and a second washcoat comprises a second precious metal supported on a second integrated support, wherein the second precious metal and the second integrated support are different from the first precious metal and the first integrated support.

In a detailed embodiment, the first washcoat comprises: the first precious metal comprising palladium, platinum, or both, and the first integrated support comprises: alumina in an amount in the range of 1 to 30%; ceria in an amount in the range of 25 to 50%; zirconia in an amount in the range of 10 to 70%; and baria and/or strontia in an amount in the range of 1 to 10%; optionally, yttria, praseodymia, lanthana, neodymia, or combinations thereof in an amount in the range of 0 to 20% is present; and the second washcoat comprises: the second precious metal comprising rhodium, platinum, or both, and the second integrated support comprises: alumina in an amount in the range of 1 to 30%; ceria in an amount in the range of 5 to 20%; and zirconia in an amount in the range of 10 to 70%; optionally; baria and/or strontia in an amount in the range of 0 to 10% is present; and optionally, yttria, praseodymia, lanthana, neodymia, or combinations thereof in an amount in the range of 0 to 20% is present.

In some embodiments, the first washcoat forms a first layer on the carrier and the second washcoat forms a second layer on the first layer. In other embodiments, the second washcoat forms a first layer on the carrier and the first washcoat forms a second layer on the first layer. The first precious metal may further comprise rhodium and the second precious metal may further comprise palladium in an embodiment.

In other embodiments, the first washcoat forms a first longitudinal zone on the carrier and the second washcoat forms a second longitudinal zone on the first layer. The first longitudinal zone may extend from an inlet end to approximately 50% of the length of the carrier and the second longitudinal end may extend from approximately 50% of the length of the carrier to an outlet end. Variations in length are understood from 0-100% of the length (0-50%, 25-75%, 50-100% and variations in between).

In some embodiments, the washcoats may form a combination of entire layers and/or zoned portions. For example, a first washcoat comprising palladium and rhodium supported on the first integrated support may forms a first layer on the carrier and a second washcoat comprising palladium supported on the first integrated support may forms a zone on the first layer. In one embodiment, the zone may extending from an inlet end to approximately 50% of the length of the carrier. Another embodiment provides that a first washcoat comprising palladium and rhodium supported on the first integrated support forms a first layer on the carrier and a second washcoat comprising rhodium supported on a second integrated support forms a zone on the first layer, the zone extending from an approximately 50% of the length of the carrier to an outlet end.

The carrier may comprise a honeycomb flow through substrate or a wall-flow filter substrate.

Other aspects include emissions after-treatment systems for treating an exhaust stream from an engine comprising the automotive catalyst composite of any embodiment disclosed herein in flow communication with the exhaust stream.

Further aspects include methods of treating an exhaust stream comprising passing the exhaust stream through the automotive catalyst composite of any one of the embodiments disclosed herein.

Method of making composites include making a composite of mixed metal oxides comprising ceria, zirconia, alumina, and an oxide of a Group II element, the method comprising: forming an aqueous solution comprising a cerium salt, a zirconium salt, and a salt of a Group II metal, and optionally salt of a Group III metal, providing a source of alumina; mixing the aqueous solution and the source of alumina to form a mixture; adjusting the pH of the mixture with a basic agent to form a raw precipitate; isolating the raw precipitate to obtain an isolated precipitate; and calcining the isolated precipitate at a temperature of at least 600° C. to form the composite of mixed metal oxides.

### BRIEF DESCRIPTION OF THE DRAWINGS

The disclosure may be more completely understood in consideration of the following detailed description of various embodiments of the disclosure in connection with the accompanying drawings, in which:

FIG. 1 provides a process flow schematic showing prior art steps for synthesizing emission catalysts;

FIG. 2 provides a process flow schematic for an aspect provided herein where an integrated support is formed to reducing the number of processing steps;

FIG. 3 provides a non-limiting schematic of possible designs using integrated supports (IS); and

FIG. 4 provides a graph of NOx, HC and CO emissions for a three-way conversion (TWC) catalyst made with a mixed metal oxide embodiment disclosed herein as compared to a TWC catalyst made with a comparative mixed metal oxide.

### DETAILED DESCRIPTION

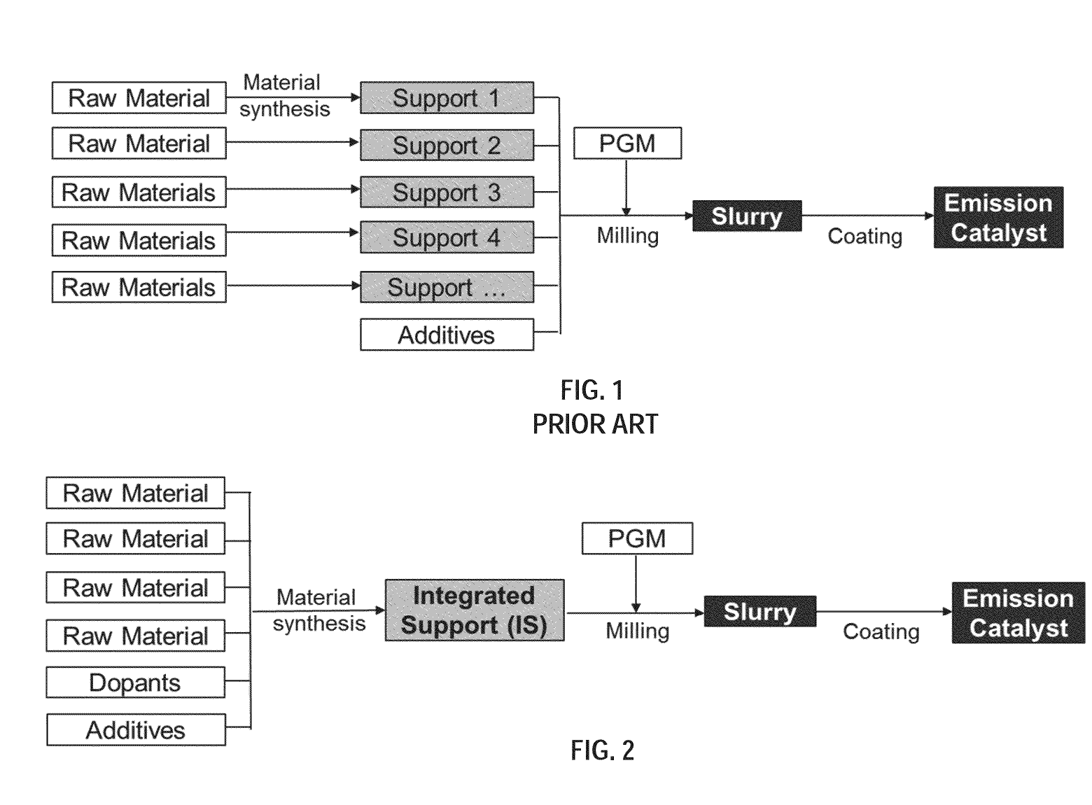

Provided are integrated supports for emissions catalysts where a single component is an integration of alumina, ceria, zirconia, Group III metal oxides (dopants, e.g., La₂O₃, Y₂O₃, Nd₂O₃, Pr₆O₁₁), Group II metal oxides (additives, e.g., BaO, SrO, CaO, MgO), and optionally other transition metal oxides into a composite via a controlled co-precipitation process. The integrated composite is used as the sole support or carrier for platinum group metals (PGM), drastically simplifying prior art formulation processes for catalytic converter making as depicted in FIG. 1.

The following terms shall have, for the purposes of this application, the respective meanings set forth below.

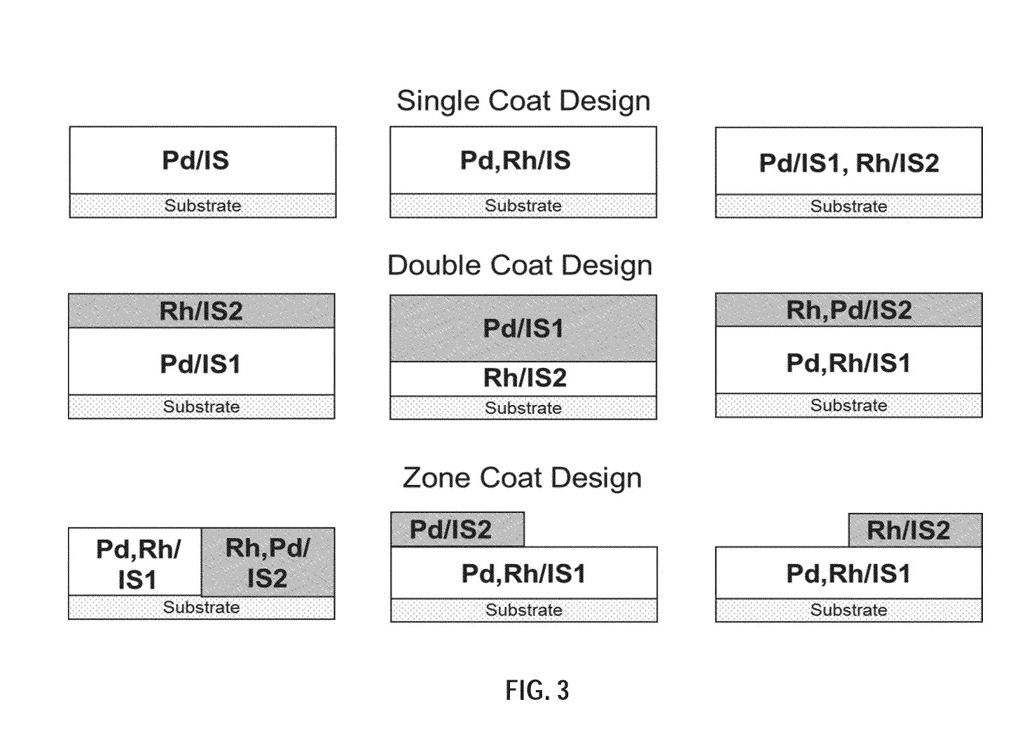

“Integrated support” is a composite material for preparation of catalytic washcoats that provides multiple metal oxides in a single material. Integrated supports can act as a sole support for PGM-containing catalytic converters. As shown in FIG. 2, the concept of the integrated support relies on material syntheses to finish up the major part of a formulation design which drastically eases the subsequent slurry formulation step. To this end, a number of raw materials including dopants and additives is coprecipitated in a one-pot synthesis to give the target integrated support with functions such as oxygen storage/release and PGM-support interactions. Appropriate synthetic measures and after-treatments need to be applied to the composite to achieve desired properties such as high thermal stability and porosity. As desired and depicted in FIG. 3, multiple integrated supports with different characteristics can be used in the same washcoat to support one or more precious metals.

“Colloidal alumina” refers to a suspension of nano-sized alumina particles comprising aluminum oxide, aluminum hydroxide, aluminum oxyhydroxide, or a mixture thereof. Anions such as nitrate, acetate and formate may coexist in a colloidal alumina suspension. In one or more embodiments, the colloidal alumina is suspended in deionized water in solids loadings in the range of 5% to 50% by weight.

“Random mixture” refers to the absence of a deliberate attempt to load or impregnate one material with another. For example, incipient wetness is excluded from randomly mixing because of the choice to impregnate one ingredient with another.

“Ceria-zirconia solid solution” refers to a mixture of ceria, zirconia, and optionally one or more rare earth metal oxides other than ceria whereas the mixture exists in a homogeneous phase.

“Platinum group metal components” refer to platinum group metals or their oxides.

“Hydrothermal aging” refers to aging of a powder sample at a raised temperature in the presence of steam. In this invention, the hydrothermal aging was performed at 950° C. or 1050° C. in the presence of 10 vol. % of steam under air.

“Hydrothermal treatment” refers to the treatment of an aqueous suspension sample at a raised temperature in a sealed vessel. In one or more embodiments, the hydrothermal treatment is performed at temperatures at 80-300° C. in a pressure-resistant steel autoclave.

“BET surface area” has its usual meaning of referring to the Brunauer-Emmett-Teller method for determining surface area by N₂-adsorption measurements. Unless otherwise stated, “surface area” refers to BET surface area.

“Rare earth metal oxides” refer to one or more oxides of scandium, yttrium, and the lanthanum series defined in the Periodic Table of Elements.

“Washcoat” is a thin, adherent coating of a catalytic or other material applied to a refractory substrate, such as a honeycomb flow through monolith substrate or a filter substrate, which is sufficiently porous to permit the passage there through of the gas stream being treated. A “washcoat layer,” therefore, is defined as a coating that is comprised of support particles. A “catalyzed washcoat layer” is a coating comprised of support particles impregnated with catalytic components.

“TWC catalysts” comprise one or more platinum group metals (e.g., platinum, palladium, rhodium, rhenium and iridium) disposed on a support, which can be a mixed metal oxide as disclosed herein or a refractory metal oxide support, e.g., a high surface area alumina coating. The support is carried on a suitable carrier or substrate such as a monolithic carrier comprising a refractory ceramic or metal honeycomb structure, or refractory particles such as spheres or short, extruded segments of a suitable refractory material. The refractory metal oxide supports may be stabilized against thermal degradation by materials such as zirconia, titania, alkaline earth metal oxides such as baria, calcia or strontia or, most usually, rare earth metal oxides, for example, ceria, lanthana and mixtures of two or more rare earth metal oxides. For example, see U.S. Pat. No. 4,171,288 (Keith). TWC catalysts are formulated to include an oxygen storage component.

“Support” in a catalyst washcoat layer refers to a material that receives precious metals, stabilizers, promoters, binders, and the like through association, dispersion, impregnation, or other suitable methods. Examples of supports include, but are not limited to, high surface area refractory metal oxides and composites containing oxygen storage components such as the mixed metal oxides disclosed herein. The high surface area refractory metal oxide supports preferably display other porous features including but not limited to a large pore radius and a wide pore distribution. As defined herein, such metal oxide supports exclude molecular sieves, specifically, zeolites. High surface area refractory metal oxide supports, e.g., alumina support materials, also referred to as “gamma alumina” or “activated alumina”, typically exhibit a BET surface area in excess of 60 square meters per gram (“m²/g”), often up to about 200 m²/g or higher. Such activated alumina is usually a mixture of the gamma and delta phases of alumina, but may also contain substantial amounts of eta, kappa and theta alumina phases. Refractory metal oxides other than activated alumina can be used as a support for at least some of the catalytic components in a given catalyst. For example, bulk ceria, zirconia, alpha alumina and other materials are known for such use. Although many of these materials suffer from the disadvantage of having a considerably lower BET surface area than activated alumina, that disadvantage tends to be offset by a greater durability of the resulting catalyst.

“Flow communication” means that the components and/or conduits are adjoined such that exhaust gases or other fluids can flow between the components and/or conduits.

“Downstream” refers to a position of a component in an exhaust gas stream in a path further away from the engine than the component preceding component. For example, when a diesel particulate filter is referred to as downstream from a diesel oxidation catalyst, exhaust gas emanating from the engine in an exhaust conduit flows through the diesel oxidation catalyst before flowing through the diesel particulate filter. Thus, “upstream” refers to a component that is located closer to the engine relate to another component.

In the present disclosure, “%” refers to “wt. %” or “mass %”, unless otherwise stated.

### Preparation of Mixed Metal Oxide Composites

In general terms, which will be exemplified below, the mixed metal oxide composites are prepared by mixing salts of cerium, zirconium, and any desired Group II metals such as magnesium, calcium, barium, and/or strontium, along with salts of any other desired rare earth metals in water to form an aqueous solution at ambient temperature to 80° C. A source of alumina, such as a colloidal alumina suspension or gamma-alumina, is then added to the aqueous solution to form a mixture. The pH of the mixture is adjusted with a basic agent to form a raw precipitate. An exemplary pH range is 6.0 to 11.0. The basic agent may comprises ammonia, ammonium carbonate, ammonium bicarbonate, an alkaline metal hydroxide, an alkaline metal carbonate, an alkaline metal bicarbonate, an alkaline earth metal hydroxide, an alkaline earth metal carbonate, an alkaline earth metal bicarbonate, or combinations thereof. The raw precipitate is isolated or purified to form an isolated or purified precipitate. The isolated or purified precipitate is calcined to form the composite of mixed oxides. Calcining usually occurs under conditions of at least 600° C. in a suitable oven or furnace. Another optional processing step is hydrothermally treating the raw precipitate at a temperature of at least 80° C. or even 300° C. An optional further processing step includes treatment of the raw precipitate with an organic agent such as an anionic surfactant, a cationic surfactant, a zwitterionic surfactant, a non-ionic surfactant, a polymeric surfactant, or combinations thereof.

Before describing several exemplary embodiments of the invention, it is to be understood that the invention is not limited to the details of construction or process steps set forth in the following description. The invention is capable of other embodiments and of being practiced in various ways. In the following, preferred designs for the mixed metal oxide composites are provided, including such combinations as recited used alone or in unlimited combinations, the uses for which include catalysts, systems, and methods of other aspects of the present invention.

In embodiment 1, provided is a composite of mixed metal oxides comprising by weight of the composite: alumina in an amount in the range of 1 to 50%; ceria in an amount in the range of 1 to 50% zirconia in an amount in the range of 10 to 70%; and one or more oxides of Group II elements in an amount in the range of 1 to 10%; optionally, one or more oxides Group III elements in an amount in the range of 0 to 20% is present. Embodiment 1 may have one or more of the following optional design features:

a BET specific surface area of at least 24 m²/g after aging at 1050° C. for 12 hours in air plus 10% steam;

the alumina may be formed from a colloidal alumina precursor;

the one or more oxides of Group II elements comprises baria, strontia, calcia, magnesia, or combinations thereof;

the one or more oxides of Group III elements comprises yttria, praseodymia, lanthana, neodymia, or combinations thereof;

the composite of mixed metal oxides is effective as an oxygen storage component and/or a precious metal support;

alumina is present in an amount, by weight of the composite, in the range of 5 to 45%, or 10 to 35%, or even 15 to 30%, or even 18-25%;

ceria is present in an amount, by weight of the composite, in the range of 5 to 45%, or 5 to 35%, or 10 to 30%;

zirconia is present in an amount, by weight of the composite, in the range of 30 to 60%, or 35-55%;

baria, strontia, calcia, magnesia, or combinations thereof is present, by weight of the composite, in an amount in the range of 1 to 5%;

lanthana yttria, praseodymia, neodymia, or combinations thereof is present, by weight of the composite, in an amount in the range of 2 to 15%;

ceria and zirconia are provided as a solid solution; and the phase of the ceria-zirconia solid solution may be cubic, tetragonal or a combination thereof.

In embodiment 2, provided is a catalyst for treating engine exhaust comprising a catalytic material coated on a carrier, the catalytic material comprising: the composite of mixed metal oxide of embodiment 1 or any of its detailed embodiments as an integrated support and a precious metal component, which may be selected from the group consisting of palladium, rhodium, platinum, and combinations thereof supported thereon. A detailed embodiment provides that the catalyst of claim comprises the composite of mixed metal oxides in the range of about 0.1 g/in³ to about 3.5 g/in³. The precious metal component can be present in the range of about 1 g/ft³ to about 300 g/ft³ (or 1.5-100 g/ft³ or even 2.0-50 g/ft³). Another detailed embodiment provides that the catalyst is a three-way conversion catalyst and the catalytic material is effective to substantially simultaneously oxidize hydrocarbons and carbon monoxide and reduce nitrogen oxides. Another detailed embodiment provides that the catalyst is a diesel oxidation catalyst and the catalytic material is effective to substantially simultaneously oxidize hydrocarbons and carbon monoxide. The integrated support may be effective as the only precious metal support for the catalytic material. The catalytic material may be free from bulk alumina and/or ceria and/or zirconia. The carrier of any embodiment herein may comprise a honeycomb flow through substrate or a wall-flow filter substrate.

Embodiment 2 may have one or more of the following optional design features:

formation from a single washcoat having a first integrated support with one or more precious metals supported thereon;

formation from two or more washcoats, each washcoat having its own integrated support and unique composition, where the washcoats may be combined to form a single slurry for coating on the carrier or where the washcoats may be applied separately in layers, zones, or combinations thereof on the carrier; and

formation of a first integrated support such as ceria-zirconia-alumina-baria (CZAB) to support palladium and/or platinum in combination and formation of a second integrated support such as ceria-zirconia-alumina (CZA) to support rhodium and/or platinum.

In embodiment 2.1, a first integrated support comprises, by weight of the first integrated support: alumina in an amount in the range of 1 to 30%; ceria in an amount in the range of 25 to 50%; zirconia in an amount in the range of 10 to 70%; and baria and/or strontia in an amount in the range of 1 to 10%; optionally, yttria, praseodymia, lanthana, neodymia, or combinations thereof in an amount in the range of 0 to 20% is present. This embodiment is suitable as a support for any desired precious metal, in particular, palladium and/or platinum.

In embodiment 2.2, a first integrated support comprises, by weight of the first integrated support: alumina in an amount in the range of 1 to 30%; ceria in an amount in the range of 5 to 20%; zirconia in an amount in the range of 10 to 70%; and baria and/or strontia in an amount in the range of 1 to 10%; optionally, yttria, praseodymia, lanthana, neodymia, or combinations thereof in an amount in the range of 0 to 20% is present. This embodiment is suitable as a support for any desired precious metal, in particular, rhodium and/or platinum.

In embodiment 2.3, an integrated support for rhodium or platinum comprises alumina in an amount in the range of 1 to 30%; ceria in an amount in the range of 5 to 20%; and zirconia in an amount in the range of 10 to 70%; optionally, baria and/or strontia in an amount in the range of 0 to 10% is present; and optionally, yttria, praseodymia, lanthana, neodymia, or combinations thereof in an amount in the range of 0 to 20% is present.

In embodiment 3, provided is an emissions after-treatment system for treating an exhaust stream from an engine comprising the catalysts of embodiment 2, 2.1, 2.2, and/or 2.3 or any of their detailed embodiments in flow communication with the exhaust stream.

Embodiment 4 provides a method of making a composite of mixed metal oxides comprising ceria, zirconia, alumina, and an oxide of a Group II element, the method comprising: forming an aqueous solution comprising a cerium salt, a zirconium salt, and a salt of a Group II metal, and optionally salt of a Group III metal; providing a source of; mixing the aqueous solution and the source of alumina to form a mixture; adjusting the pH of the mixture with a basic agent to form a raw precipitate; isolating the raw precipitate to obtain an isolated precipitate; and calcining the isolated precipitate at a temperature of at least 600° C. to form the composite of mixed metal oxides. Embodiment 4 can include one or more of the following steps:

hydrothermally treating the raw precipitate at a temperature of at least 80° C.;

treating the raw precipitate with an anionic surfactant, a cationic surfactant, a zwitterionic surfactant, a non-ionic surfactant, a polymeric surfactant, or combinations thereof;

the step of hydrothermally treating the raw precipitate is at a temperature of at least 80° C. and treating the raw precipitate with an anionic surfactant, a cationic surfactant, a zwitterionic surfactant, a non-ionic surfactant, a polymeric surfactant, or combinations thereof;

the surfactant is a fatty acid or a salt of a fatty acid;

the step of hydrothermally treating the raw precipitate occurs in the presence of a basic agent comprising ammonia, ammonium carbonate, ammonium bicarbonate, an alkaline metal hydroxide, an alkaline metal carbonate, an alkaline metal bicarbonate, an alkaline earth metal hydroxide, an alkaline earth metal carbonate, or an alkaline earth metal bicarbonate;

the pH is in the range of 6.0 to 11.0 and the basic agent comprises ammonia, ammonium carbonate, ammonium bicarbonate, an alkaline metal hydroxide, an alkaline metal carbonate, an alkaline metal bicarbonate, an alkaline earth metal hydroxide, an alkaline earth metal carbonate, or an alkaline earth metal bicarbonate.

In embodiment 5, provided is a method of treating an exhaust stream comprising passing the exhaust stream through the catalyst of any embodiment disclosed herein, wherein the precious metal component is selected from the group consisting of palladium, rhodium, platinum, and combinations thereof.

### Preparation of Catalyst Washcoats

TWC catalysts may be formed in a single layer or multiple layers. In some instances, it may be suitable to prepare one slurry of catalytic material and use this slurry to form multiple layers on the carrier. The catalysts can readily prepared by processes well known in the prior art. A representative process is set forth below.

The catalyst can be readily prepared in layers on a carrier. For a first layer of a specific washcoat, finely divided particles of a high surface area refractory metal oxide such as gamma alumina are slurried in an appropriate vehicle, e.g., water. To incorporate components such as precious metals (e.g., palladium, rhodium, platinum, and/or combinations of the same), stabilizers and/or promoters, such components may be incorporated in the slurry as a mixture of water soluble or water-dispersible compounds or complexes. Typically, when palladium is desired, the palladium component is utilized in the form of a compound or complex to achieve dispersion of the component on the refractory metal oxide support, e.g., activated alumina. The term “palladium component” means any compound, complex, or the like which, upon calcination or use thereof, decomposes or otherwise converts to a catalytically active form, usually the metal or the metal oxide. Water-soluble compounds or water-dispersible compounds or complexes of the metal component may be used as long as the liquid medium used to impregnate or deposit the metal component onto the refractory metal oxide support particles does not adversely react with the metal or its compound or its complex or other components which may be present in the catalyst composition and is capable of being removed from the metal component by volatilization or decomposition upon heating and/or application of a vacuum. In some cases, the completion of removal of the liquid may not take place until the catalyst is placed into use and subjected to the high temperatures encountered during operation. Generally, both from the point of view of economics and environmental aspects, aqueous solutions of soluble compounds or complexes of the precious metals are utilized. For example, suitable compounds are palladium nitrate or rhodium nitrate.

A suitable method of preparing any layer of the layered catalyst composite of the invention is to prepare a mixture of a solution of a desired precious metal compound (e.g., palladium compound) and at least one support, such as the mixed metal oxide composites disclosed herein and/or a finely divided, high surface area, refractory metal oxide support, e.g., gamma alumina, which is sufficiently dry to absorb substantially all of the solution to form a wet solid which later combined with water to form a coatable slurry. In one or more embodiments, the slurry is acidic, having, for example, a pH of about 2 to less than about 7. The pH of the slurry may be lowered by the addition of an adequate amount of an inorganic or an organic acid to the slurry. Combinations of both can be used when compatibility of acid and raw materials is considered. Inorganic acids include, but are not limited to, nitric acid. Organic acids include, but are not limited to, acetic, propionic, oxalic, malonic, succinic, glutamic, adipic, maleic, fumaric, phthalic, tartaric, citric acid and the like. Thereafter, if desired, water-soluble or water-dispersible compounds of oxygen storage components, e.g., cerium-zirconium composite, a stabilizer, e.g., barium acetate, and a promoter, e.g., lanthanum nitrate, may be added to the slurry.

In one embodiment, the slurry is thereafter comminuted to result in substantially all of the solids having particle sizes of less than about 20 microns, i.e., between about 0.1-15 microns, in an average diameter. The comminution may be accomplished in a ball mill or other similar equipment, and the solids content of the slurry may be, e.g., about 20-60 wt. %, more particularly about 30-40 wt. %.

Additional layers, i.e., the second and third layers may be prepared and deposited upon the first layer in the same manner as described above for deposition of the first layer upon the carrier.

### Carrier

In one or more embodiments, a catalytic material is disposed on a carrier.

The carrier may be any of those materials typically used for preparing catalyst composites, and will preferably comprise a ceramic or metal honeycomb structure. Any suitable carrier may be employed, such as a monolithic substrate of the type having fine, parallel gas flow passages extending therethrough from an inlet or an outlet face of the substrate, such that passages are open to fluid flow therethrough (referred to as honeycomb flow through substrates). The passages, which are essentially straight paths from their fluid inlet to their fluid outlet, are defined by walls on which the catalytic material is coated as a washcoat so that the gases flowing through the passages contact the catalytic material. The flow passages of the monolithic substrate are thin-walled channels, which can be of any suitable cross-sectional shape and size such as trapezoidal, rectangular, square, sinusoidal, hexagonal, oval, circular, etc. Such structures may contain from about 60 to about 900 or more gas inlet openings (i.e., cells) per square inch of cross section.

The carrier can also be a wall-flow filter substrate, where the channels are alternately blocked, allowing a gaseous stream entering the channels from one direction (inlet direction), to flow through the channel walls and exit from the channels from the other direction (outlet direction). A dual oxidation catalyst composition can be coated on the wall-flow filter. If such a carrier is utilized, the resulting system will be able to remove particulate matters along with gaseous pollutants. The wall-flow filter carrier can be made from materials commonly known in the art, such as cordierite or silicon carbide.

The carrier may be made of any suitable refractory material, e.g., cordierite, cordierite-alumina, silicon nitride, zircon mullite, spodumene, alumina-silica magnesia, zircon silicate, sillimanite, a magnesium silicate, zircon, petalite, alumina, an aluminosilicate and the like.

The carriers useful for the catalysts of the present invention may also be metallic in nature and be composed of one or more metals or metal alloys. The metallic carriers may be employed in various shapes such as corrugated sheet or monolithic form.

Preferred metallic supports include the heat resistant metals and metal alloys such as titanium and stainless steel as well as other alloys in which iron is a substantial or major component. Such alloys may contain one or more of nickel, chromium and/or aluminum, and the total amount of these metals may advantageously comprise at least 15 wt % of the alloy, e.g., 10-25 wt % of chromium, 3-8 wt % of aluminum and up to 20 wt % of nickel. The alloys may also contain small or trace amounts of one or more other metals such as manganese, copper, vanadium, titanium and the like. The surface of the metal carriers may be oxidized at high temperatures, e.g., 1000° C. and higher, to improve the resistance to corrosion of the alloys by forming an oxide layer on the surfaces of the carriers. Such high temperature-induced oxidation may enhance the adherence of the refractory metal oxide support and catalytically promoting metal components to the carrier.

In alternative embodiments, one or more catalyst compositions may be deposited on an open cell foam substrate. Such substrates are well known in the art, and are typically formed of refractory ceramic or metallic materials.

### Aging and Analytics of Composites

For aging, powder samples were placed in high temperature resistant ceramic boats and heated in a horizontal tube furnace fit with a quartz tube. Aging was carried out under a flow of air and 10% steam controlled by a water pump. The temperature was ramped up to a desired temperature and remained at the desired temperature for a desired amount of time. A calibrated thermocouple was placed nearby the samples to control the aging temperature.

### EXAMPLES

The following examples illustrate the preparation and characterization of representative embodiments related to the present invention. However, the present invention is not limited to these examples.

### Example 1

This example describes the preparation of a mixed metal oxide composite (CZAB) of cerium, zirconium, lanthanum, yttrium, barium, and aluminum oxides in respective mass proportions of 25%, 48%, 4%, 4%, 1%, and 18%. A nitrate solution was prepared by mixing 336 g of a zirconium oxynitrate solution (20.0% on a ZrO₂ basis), 37.3 g of a yttrium nitrate solution (15.0% on a Y₂O₃ basis), 21.1 g of a lanthanum nitrate solution (26.5% on a La₂O₃ basis), 120.7 g of a cerium nitrate solution (29.0% on a CeO₂ basis), 2.39 g of barium nitrate crystals, and 280 g of de-ioned water. A colloidal alumina dispersion was prepared by dispersing 33.4 g of a commercial colloidal alumina powder (75.5% on a Al₂O₃ basis) in 218.6 g of de-ioned water. A diluted ammonia solution was prepared by mixing 420 g of a 29.4% ammonia solution and 560 g of de-ioned water. The nitrate solution, the colloidal alumina dispersion, and the diluted ammonia solution were mixed together to give a raw precipitate with a pH of 9.8. The precipitate was collected by filtration and washed with de-ioned water to remove soluble nitrates. The frit was re-dispersed in de-ioned water to form a slurry of a solid percentage of 10%. The pH of the slurry was adjusted to 10.0 with a 29.4% ammonia solution. Hydrothermal treatment of the slurry was conducted in an autoclave at 150° C. for 4 hours. After the hydrothermal treatment, the slurry was heated to 70° C. Under stirring, 63.0 g of lauric acid was added in small portions to the mixture which was kept at 70° C. for 1 hour. The solid was collected by filtration and washed with de-ioned water. The washed frit was dried at 120° C. overnight and calcined at 900° C. for 4 hours to give the target composite quantitatively as a pale yellow powder.

BET Surface area after 12 hours at 1050° C. in air and 10% steam: 28.6 m²/g.

### Example 2

This example describes the preparation of a three-way conversion (TWC) catalyst comprising a single layered washcoat architecture using the inventive composite of Example 1 as the sole support for platinum group metals (PGM). Pd and Rh were separately supported on a portion of the CZAB composite of Example 1 by a standard wetness incipient impregnation method followed by calcination at 550° C. for 2 hours. The first impregnation was performed by adding a diluted palladium nitrate solution to 2.45 g/in³ of Example 1 resulting in 57.00 g/ft³ Pd. The second impregnation was carried out by adding a diluted rhodium nitrate solution to 0.55 g/in³ of Example 1 resulting in 3.00 g/ft³ Rh. The two PGM-impregnated powders were dispersed in de-ioned water and then ball-milled to give a slurry with 90% of the particles less than 15 microns. The slurry was coated onto a ceramic monolith flow through substrate which was dried at 110° C. and calcined at 550° C. in air to give a total washcoat loading of 3.04 g/in³.

### Example 3

### Comparative

This example describes the preparation of a conventional TWC catalyst, of a comparable composition to Example 2, comprising a single layered washcoat architecture using a high surface area gamma-alumina (BET surface area: 150 m²/g) and a stabilized ceria-zirconia composite (CeO₂: 30%) as the supports for PGM. Pd and Rh were supported on the ceria-zirconia composite and the alumina, respectively, by a standard wetness incipient impregnation method followed by calcination at 550° C. for 2 hours. The first impregnation was carried out by adding a diluted palladium nitrate solution to 2.43 g/in³ of the stabilized ceria-zirconia composite resulting in 57.00 g/ft³ Pd. The second impregnation was performed by adding a diluted rhodium nitrate solution to 0.55 g/in³ of the alumina resulting in 3.00 g/ft³ Rh. The two PGM-impregnated powders were dispersed in de-ioned water containing barium acetate of 0.03 g/in³ BaO and then ball-milled to give a slurry with 90% of the particles less than 15 microns. The slurry was coated onto a ceramic monolith flow through substrate which was dried at 110° C. and calcined at 550° C. in air to give a total washcoat loading of 3.04 g/in³.

### Example 4

### Aging and Testing

Cores of 1.0 inch in radius and 1.5 inches in length of Example 2 and Comparative Example 3 were drilled from the corresponding coated monolith flow through catalysts. The core samples were aged in a horizontal tube furnace fit with a quartz tube under a flow of air and 10% steam controlled by a water pump. The temperature was ramped to 1050° C. in 45 minutes and remained at the same temperature for 12 hours. A calibrated thermocouple was placed in the inlet of the samples to control the aging temperature.

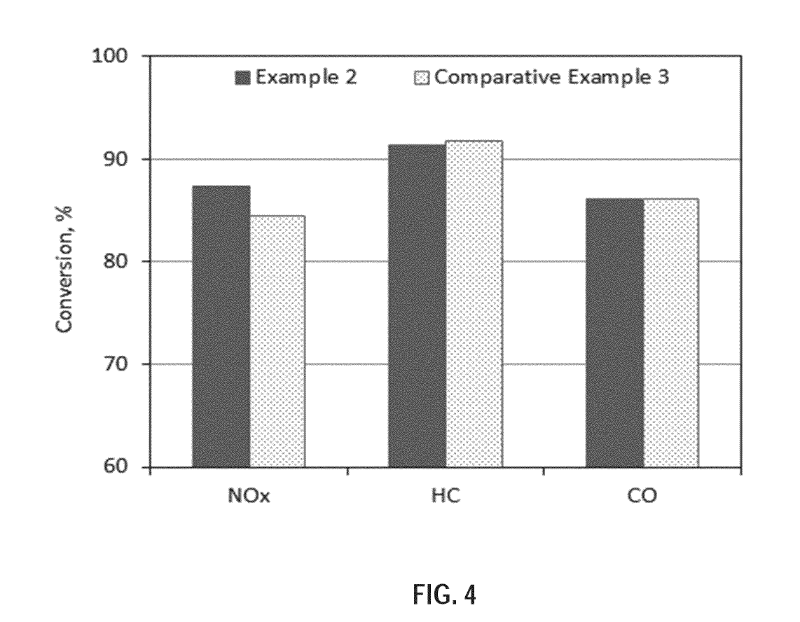

The aged catalysts were tested on a lab reactor that is capable of simulating New European Drive Cycles (NEDC) using temperature and emissions trances recorded on a gasoline engine. FIG. 4 provides conversions of NOₓ, HC and CO emissions during the simulated NEDC tests. The data show that the conversion levels obtained by using Example 2 are either superior or equivalent to those obtained by using Comparative Example 3.

### Example 5

This example describes the preparation of a mixed metal oxide composite (CZAB) of cerium, zirconium, lanthanum, yttrium, barium, and aluminum oxides in respective mass proportions of 27%, 37%, 4%, 4%, 3%, and 25%. A nitrate solution was prepared by mixing 555 g of a zirconium oxynitrate solution (20.0% on a ZrO₂ basis), 80 g of a yttrium nitrate solution (15.0% on a Y₂O₃ basis), 45.3 g of a lanthanum nitrate solution (26.5% on a La₂O₃ basis), 279.3 g of a cerium nitrate solution (29.0% on a CeO₂ basis), 15.4 g of barium nitrate crystals, and 300 g of de-ioned water. A colloidal alumina dispersion was prepared by dispersing 99.5 g of a commercial colloidal alumina powder (75.5% on a Al₂O₃ basis) in 650.5 g of de-ioned water. A diluted ammonia solution was prepared by mixing 900 g of a 29.4% ammonia solution and 1200 g of de-ioned water. The nitrate solution, the colloidal alumina dispersion, and the diluted ammonia solution were mixed together to give a raw precipitate with a pH of 9.8. The precipitate was collected by filtration and washed with de-ioned water to remove soluble nitrates. The frit was re-dispersed in de-ioned water to form a slurry of a solid percentage of 10%. The pH of the slurry was adjusted to 10.0 with a 29.4% ammonia solution.

Hydrothermal treatment of the slurry was conducted in an autoclave at 150° C. for 4 hours. After the hydrothermal treatment, the slurry was heated to 70° C. Under stirring, 135 g of lauric acid was added in small portions to the mixture which was kept at 70° C. for 1 hour. The solid was collected by filtration and washed with de-ioned water. The washed frit was dried at 120° C. overnight and calcined at 900° C. for 4 hours to give the target composite quantitatively as a pale yellow powder.

BET Surface area after 12 hours at 1050° C. in air and 10% steam: 35.4 m²/g.

### Example 6

This example describes the preparation of a four-way conversion (FWC) catalyst comprising a single layered washcoat architecture using the inventive composite of Example 5 as the sole support for platinum group metals (PGM). Pd and Rh were separately supported on a portion of the CZAB composite of Example 5 by a standard wetness incipient impregnation method followed by calcination at 550° C. for 2 hours. The first impregnation was performed by adding a diluted palladium nitrate solution to 1.47 g/in³ of Example 5 resulting in 27.0 g/ft³ Pd. The second impregnation was carried out by adding a diluted rhodium nitrate solution to 0.49 g/in³ of Example 4 resulting in 3.0 g/ft³ Rh. The two PGM-impregnated powders were dispersed in de-ioned water and then ball-milled to give a slurry with 90% of the particles less than 3.5 microns. The slurry was coated onto a ceramic wall flow substrate (filter) which was dried at 110° C. and calcined at 550° C. in air to give a total washcoat loading of 1.98 g/in³.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed:

1. A composite of mixed metal oxides comprising, by weight of the composite:
alumina in an amount in the range of 1 to 50%;
ceria in an amount in the range of 1 to 50%
zirconia in an amount in the range of 10 to 70%; and
one or more oxides of Group II elements in an amount in the range of 1 to 10%;
optionally, one or more oxides Group III elements in an amount in the range of 0 to 20% is present;
wherein the composite of mixed metal oxides has a BET specific surface area of at least 24 m²/g after aging at 1050° C. for 12 hours in air plus 10% steam.

2. The composite of claim 1, wherein the alumina is formed from a colloidal alumina precursor.

3. The composite of mixed metal oxides of claim 1, wherein the one or more oxides of Group II elements comprises baria, strontia, calcia, magnesia, or combinations thereof.

4. The composite of mixed metal oxides of claim 1, wherein the one or more oxides of Group III elements comprises yttria, praseodymia, lanthana, neodymia, or combinations thereof.

5. The composite of mixed metal oxides of claim 1 that is effective as an oxygen storage component and/or a precious metal support.

6. The composite of mixed metal oxides of claim 1 comprising, by weight:
alumina in an amount in the range of 10 to 35%;
ceria in an amount in the range of 5 to 35%;
zirconia in an amount in the range of 35 to 55%;
baria, strontia, calcia, magnesia, or combinations thereof in an amount in the range of 1 to 5%; and
lanthana yttria, praseodymia, neodymia, or combinations thereof in an amount in the range of 2 to 15%.

7. An automotive catalyst composite comprising a catalytic material on a carrier, the catalytic material comprising:
a first precious metal supported on a first integrated support that comprises, by weight of the first integrated support:
alumina in an amount in the range of 1 to 50%;
ceria in an amount in the range of 1 to 50%
zirconia in an amount in the range of 10 to 70%; and
one or more oxides of Group II elements in an amount in the range of 1 to 10%;
optionally, one or more oxides Group III elements in an amount in the range of 0 to 20% is present.

8. The automotive catalyst composite of claim 7, wherein first integrated support is effective as the only precious metal support for the catalytic material.

9. The automotive catalyst of composite of claim 7, wherein the catalytic material is free from bulk alumina and/or ceria and/or zirconia.

10. The automotive catalyst composite of claim 7, wherein the first precious metal comprises platinum, palladium, rhodium, or combinations thereof.

11. The automotive catalyst composite of claim 7 comprising alumina in an amount in the range of 18-25% by weight.

12. The automotive catalyst composite of claim 7, wherein the first precious metal comprises palladium, platinum, or both, and not rhodium, and the catalytic material further comprises a second precious metal comprising rhodium on a second integrated support that comprises, by weight of the second integrated support:
alumina in an amount in the range of 1 to 50%;
ceria in an amount in the range of 1 to 50%; and
zirconia in an amount in the range of 10 to 70%;
optionally, one or more oxides of Group II elements in an amount in the range of 0 to 10% is present;
optionally, one or more oxides Group III elements in an amount in the range of 0 to 20% is present.

13. The automotive catalyst composite of claim 7, wherein the first precious metal comprises palladium, platinum, or both, and the first integrated support comprises, by weight of the first integrated support:
alumina in an amount in the range of 1 to 30%;
ceria in an amount in the range of 25 to 50%;
zirconia in an amount in the range of 10 to 70%; and
baria and/or strontia in an amount in the range of 1 to 10%;
optionally, yttria, praseodymia, lanthana, neodymia, or combinations thereof in an amount in the range of 0 to 20% is present.

14. The automotive catalyst composite of claim 7, wherein the first precious metal comprises rhodium, platinum, or both, and the first integrated support comprises, by weight of the first integrated support:
alumina in an amount in the range of 1 to 30%;
ceria in an amount in the range of 5 to 20%;
zirconia in an amount in the range of 10 to 70%; and
baria and/or strontia in an amount in the range of 1 to 10%;
optionally, yttria, praseodymia, lanthana, neodymia, or combinations thereof in an amount in the range of 0 to 20% is present.

15. The automotive catalyst composite of claim 7 formed from a single washcoat that comprises the first precious metal supported on the first integrated support and a second precious metal supported on a second integrated support, wherein the second precious metal and the second integrated support are different from the first precious metal and the first integrated support.

16. The automotive catalyst composite of claim 7 formed from a first washcoat that comprises the first precious metal supported on the first integrated support and a second washcoat that comprises a second precious metal supported on a second integrated support, wherein the second precious metal and the second integrated support are different from the first precious metal and the first integrated support.

17. The automotive catalyst composite of claim 16, wherein
the first precious metal comprises palladium, platinum, or both, and the first integrated support comprises:
alumina in an amount in the range of 1 to 30%;
ceria in an amount in the range of 25 to 50%
zirconia in an amount in the range of 10 to 70%; and
baria and/or strontia in an amount in the range of 1 to 10%;
optionally, yttria, praseodymia, lanthana, neodymia, or combinations thereof in an amount in the range of 0 to 20% is present; and
the second precious metal comprises rhodium, platinum, or both, and the second integrated support comprises:
alumina in an amount in the range of 1 to 30%;
ceria in an amount in the range of 5 to 20%; and
zirconia in an amount in the range of 10 to 70%;
optionally, baria and/or strontia in an amount in the range of 0 to 10% is present; and
optionally, yttria, praseodymia, lanthana, neodymia, or combinations thereof in an amount in the range of 0 to 20% is present.

18. The automotive catalyst composite of claim 17, wherein the first washcoat forms a first layer on the carrier and the second washcoat forms a second layer on the first layer.

19. The automotive catalyst composite of claim 17, wherein the second washcoat forms a first layer on the carrier and the first washcoat forms a second layer on the first layer.

20. The automotive catalyst composite of claim 17, wherein the first precious metal further comprises rhodium and the second precious metal further comprises palladium.

21. The automotive catalyst composite of claim 20, wherein the first washcoat forms a first layer on the carrier and the second washcoat forms a second layer on the first layer.

22. The automotive catalyst composite of claim 20, wherein the first washcoat forms a first longitudinal zone on the carrier and the second washcoat forms a second longitudinal zone on the first layer.

23. The automotive catalyst composite of claim 22, wherein the first longitudinal zone extends from an inlet end to approximately 50% of the length of the carrier and the second longitudinal end extends from approximately 50% of the length of the carrier to an outlet end.

24. The automotive catalyst composite of claim 7, wherein a first washcoat comprising palladium and rhodium supported on the first integrated support forms a first layer on the carrier and a second washcoat comprising palladium supported on the first integrated support forms a zone on the first layer, the zone extending from an inlet end to approximately 50% of the length of the carrier.

25. The automotive catalyst composite of claim 7, wherein a first washcoat comprising palladium and rhodium supported on the first integrated support forms a first layer on the carrier and a second washcoat comprising rhodium supported on a second integrated support forms a zone on the first layer, the zone extending from an approximately 50% of the length of the carrier to an outlet end.

26. The automotive catalyst composite of claim 7, wherein the carrier comprises a honeycomb flow through substrate or a wall-flow filter substrate.

27. An emissions after-treatment system for treating an exhaust stream from an engine comprising the automotive catalyst composite of claim 7 in flow communication with the exhaust stream.

28. A method of treating an exhaust stream comprising passing the exhaust stream through the automotive catalyst composite of claim 7.
